(19) United States
(12) Patent Application Publication
(10) Pub. No.: US 2007/0049972 A1
(43) Pub. Date: Mar. 1, 2007

(54) Method and apparatus for locating a pacifier

(76) Inventors: Darryl Jones, Marietta, GA (US); Tanya Natasha Jones, Marietta, GA (US)

Correspondence Address: WEST & ASSOCIATES, A PC, 2815 MITCHELL DRIVE, SUITE 209, WALNUT CREEK, CA, 94598, US

(21) Appl. No.: 11/217,941

(22) Filed: Aug. 31, 2005

(51) Int. Cl. A61J 17/00

(52) U.S. Cl. 606/234

(57) ABSTRACT

A pacifier locator system comprising a pacifier including a housing, a speaker located within said housing, a light source associated with said pacifier, a transmitter capable of transmitting at least one signal and a receiver associated with said pacifier, wherein said speaker emits an audible tone upon receiving said at least one signal and wherein said light source emits a visual signal upon receiving said at least one signal.

### BACKGROUND

1. Field of the Invention

The present invention relates generally to an apparatus for assisting in the location of a lost or misplaced object.

2. Description of Related Art

In recent years, advances in technology have allowed manufacturers of various devices and objects to make their devices and objects smaller and smaller. While smaller devices are often more convenient, when the devices and objects are lost or misplaced, location of these new smaller devices and objects is oftentimes difficult, frustrating and many times impossible. Consequently, owners of these devices and objects oftentimes give up searching for the devices, often simply electing to replace them rather than continue searching for the missing device or object. However, in certain circumstances, such as when an infant is crying over a lost pacifier, location of the pacifier becomes virtually essential. Over the years, various apparatuses have been developed to assist in the location of objects which have various advantages and shortcomings.

U.S. Pat. No. 4,507,653, issued on Mar. 26, 1985, to Bayer, describes an object finder device which can be mounted on a personal item and responds by an audible signal to a predetermined sound such as hand clapping, whistling, and the like. The effectiveness of this device would necessarily be limited to the range where the designated sound reaches a threshold level.

U.S. Pat. No. 4,558,307, issued Dec. 10, 1985, to Lienart van Lidt de Jeude, describes a light-actuated reminder device for attachment to keys, a wallet or a diary, and the like, which would normally be left in a pocket or cabinet where light stimulation is absent. Upon exposure to light for a predetermined time, an alarm within the device sounds. A cover is provided for placement over the device sensor when not in operation. This system is impractical in that a cover could be easily lost. Also, the item could be left at a location with the cover on and then the location for the item could be easily forgotten, resulting in inoperativeness of the system and loss of the item.

U.S. Pat. No. 5,598,143, issued on Jan. 28, 1997, to Wentz, describes a device for mounting in a location, such as near a television, which selectively signals a plurality of control devices known as beepers upon actuation so as to activate a sound signal from each selected control device so as to disclose their location. This system does not provide for the location of personal items, etc. but only to hand-held remote control devices.

U.S. Pat. No. 5,629,677, issued on May 13, 1997, to Staino, Jr. describes a locator system particularly designed for eyeglasses. The eyeglass holder acts as the finding device and signals are transmitted from the holder to a device on the eyeglasses which emits an audible signal upon manual activation of the combination holder and finding device. This system is practically confined to eyeglasses and is not appropriate for use with other personal items which are subject to loss.

U.S. Pat. No. 5,638,051, issued on Jun. 10, 1997, to Sacca et al., describes a finding device primarily used for the location of a remote control useful in controlling a television. The primary novelty apparent in this description is reduced power consumption of the receiver which activates an audible signaling device. This system is not amenable to finding a variety of discreet personal items. The finder is also subject to being mislaid, thus prejudicing the reliability of the locator system.

U.S. Pat. No. 5,673,023, issued Sep. 30, 1997, to Smith, describes a locating system primarily designed for locating remote control units for television, etc. which employs both light signaling and simulated speech sound signaling at the receiver portion, which is located on one of the respective remote control units. This system would not be practical for finding small objects such as keys, wallets or pacifiers, and other objects.

U.S. Pat. No. 5,677,673, issued Oct. 14, 1997, to Kipnis describes a wall-mounted personal item locator unit which has a plurality of labeled buttons which correspond to receiver units mountable on objects subject to loss. Each mountable receiver unit emits a characteristic sound such that upon activation of the item locator unit, the desired object may be found by listening for its sound emission. An alternative system employs a transportable transmitter unit. The transmitter continually transmits an activation signal intermittently upon actuation. The selected receiver unit then sends out a signal back to the transmitter activating a flashing light such as a light-emitting diode (LED). As the user approaches the lost item, the rate of flashing increases. This light-emitting mode is used in addition to the sound-emitting device on the receiver. This system is of limited usefulness in the wall-mounted embodiment due to necessarily limited range. In the case of the portable locator, the locating device is itself subject to loss, thus compromising the system's overall reliability.

U.S. Pat. No. 5,680,105, issued Oct. 21, 1997, to Hedric describes a locating device for locating household objects by means of matching coded senders and receivers mounted on a rack when not in use. The elements for attachment are coded to respond to a multiplicity of corresponding individual finders. This system suffers from a design having a large number of parts which are subject to loss. The cost of having individual finders with separate circuits results in an unduly expensive locator system. The elements for attachment are relatively large and would not be appropriate for small objects such as key chains and the system would necessarily be limited in range due to the small size of the finders.

U.S. Pat. No. 5,689,238, issued on Nov. 18, 1997, to Cannon, Jr. et al. describes an object locator system particularly adapted to finding marked documents in a random file in a file cabinet. Means are disclosed for providing the file with either a sound-emitting device which is interrogated by a coded finder, or a homing device which responds to a particular coded electronic signal sending device with an audible output which increases in loudness upon approaching the desired file. This system is subject to loss or misplacement of the locator device and the disclosure is restricted to a filing system environment.

U.S. Pat. No. 5,939,981, issued on Aug. 17, 1999 to Renney describes an item locator with attachable receiver/transmitter. There is no provision, however, for locating the item locator if it should be misplaced.

While the above-described devices are useful for the casual user, they provide little or no assistance to the hearing-impaired and none of these products are appropriate for use with a pacifier as they may pose a choking hazard or pose other risks of injury to an infant.

What is needed is a locator device that is integrated with a pacifier that can offer provide auditory and/or visual indications of the item's location.

### BRIEF DESCRIPTION OF THE DRAWINGS

FIG. 1 is a rear view of a pacifier associated with a locator system.

FIG. 2 is a front view of the pacifier associated with a locator system shown in FIG. 1.

FIG. 3 is a side view of the pacifier associated with a locator system shown in FIGS. 1 and 2.

FIG. 4 is an isometric view of the pacifier associated with a locator system shown in FIGS. 1-3.

FIG. 5 is a cross-sectional view of the pacifier associated with a locator system as shown and indicated in FIG. 3.

FIG. 6 is a top view of a base unit associated with a pacifier locator system.

FIG. 7 is a top view of a mobile locator unit associated with a pacifier locator system.

### DETAILED DESCRIPTION

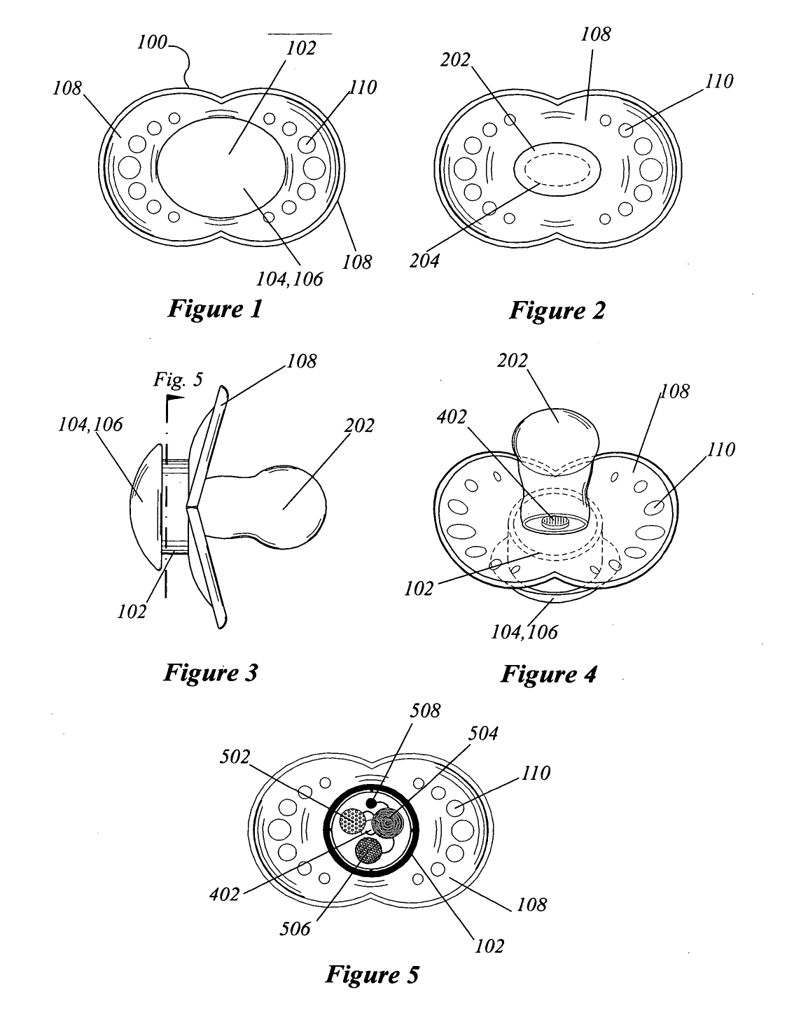

FIGS. 1 and 2 depict the back and front sides of a pacifier 100, respectively. In the embodiment shown in FIGS. 1 and 2, the pacifier 100 includes a housing 102.

In the embodiment shown in FIG. 1, the pacifier 100 includes an identifier 104. In the embodiment shown in FIG. 1, the identifier 104 can be a transparent plastic cover, removably attached to the housing 102. In the embodiment shown in FIG. 1, one or more light sources (502, FIG. 5) are located behind the plastic cover which can illuminate when the pacifier 100 is activated by a pager device, thus assisting in the location of the pacifier 100 and any associated object. In the embodiment shown in FIG. 1, the light sources are red light emitting diodes (LEDs). However, in alternate embodiments, any convenient and/or known light source of any color may be used. Additionally, in alternate embodiments, the location and number of light sources may vary. In still further alternate embodiments, the plastic cover can be irremovably attached to the housing and/or the pacifier.

In alternate embodiments, the identifier can be embossed into the housing or affixed or associated with the pacifier 100 in any convenient and/or known manner or may be absent. In still further alternate embodiments, the housing 402 can have a unique color associated with a button on a pager device. In still further alternate embodiments, the housing 102 can have a unique shape associated with a button or marking on a pager device.

In the embodiment shown in FIG. 1, the identifier can simultaneously act as a removable battery cover 106. However, in alternate embodiments, the removable battery cover and the identifier can be independent components. In the embodiment shown in FIG. 1, the battery cover 106 can be removed such that the power source for the pacifier 100 can be easily replaced. In the embodiment shown in FIG. 1, the power source is an alkali battery. However in alternate embodiments, any convenient and/or known power source can be used.

The embodiment shown in FIG. 1 also includes a flanges 108. The flanges extend from the housing substantially orthogonally. In some embodiments the flanges 108 can have a substantially semi-circular shape and can curve toward the front side of the pacifier 100 to better conform to the face of an infant. In alternate embodiments, the flanges can have known and/or convenient shape and/or can be absent.

In the embodiment shown in FIG. 1, the flanges can include apertures 110. In the embodiment shown in FIG. 1, the apertures 110 are circular in a radial pattern. However, in alternate embodiment, the apertures 110 can have any known and/or convenient shape and can be dispersed within the flanges 108 in any convenient pattern. In still further embodiments, the apertures 110 may not be present.

FIG. 2 show the front side of the pacifier 100 depicted in FIG. 1. In the embodiment shown in FIG. 2, the pacifier 100 includes a nipple 202 that is attached to the housing 102. Attachment of the nipple 202 to the housing 102 can be accomplished using any know and/or convenient attachment mechanism. In the embodiment shown in FIG. 2, the nipple 202 is attached to the housing via a lip 204 which engages the proximal end of the nipple 202. In some embodiments, the nipple can be removed and replaced with the same or a substitute nipple. In the embodiment shown in FIG. 2 the nipple 202 can be made of a transparent or translucent, non-toxic, hypo-allergenic material that can safely be introduced into an infant's mouth. The nipple 202 can have any known and/or convenient shape. Additionally, in alternate embodiments, the nipple 202 can be made of any known and/or convenient material and need not be transparent and/or translucent.

FIG. 3 is a side view of the pacifier 100 shown in FIGS. 1 and 2. In the embodiment shown in FIG. 3, the nipple 202 has a bulbous distal end and the flanges 108 have a semi-spherical shape. However, in alternate embodiments, other configurations are possible.

FIG. 4 is an isometric view of the pacifier 100, shown in FIGS. 1-3. In the embodiment shown in FIG. 4, the housing includes an opening 402. In the embodiment shown in FIG. 4, the opening is partially covered. However, in alternate embodiments, the opening 402 can be unobstructed and/or absent. Additionally, in alternate embodiments, the opening 402 can have any know and/or convenient shape and/or can be located in any known and/or convenient location on the housing 102.

In the embodiment shown in FIG. 5, the pacifier 100 includes a speaker 502, a power source 504, an antenna 506 and a light source 508 located inside the housing 102 of the pacifier 100. In the embodiment shown in FIG. 5, each of the speaker 502, antenna 506 and light source 508 are attached to the power source 504. However, in alternate embodiments, each device can have its own power source or be powered in any known and/or convenient manner. In the embodiment shown in FIG. 5, the power source 504 is a battery. However, in alternate embodiments, the power source can be any known and/or convenient mechanism and/or the power source 504 could be absent and the devices 502, 506, 508 could draw power in any known and/or convenient manner.

In the embodiment shown in FIG. 5, the speaker can emit a single-tone or multi-tone frequency. In the embodiment shown in FIG. 5 the multi-tone frequency includes one high-frequency audible tone and one low-frequency audible tone. The two tones are emitted sequentially in an interlaced fashion such that at any given time the speaker 502 is either emitting a low-frequency tone or a high-frequency tone. Thus, the effect is similar to an ambulance siren. In the embodiment shown in FIG. 5, the high-frequency tone can be a tone selected from the frequency range of approximately 10,000 Hz to approximately 20,000 Hz and the low-frequency tone can be a tone selected from the frequency range of approximately 0 Hz to 10,000 Hz. However, in alternate embodiments, the high and low frequency tones can be selected from any ranges within the audible frequency spectrum. Alternatively, the two frequency tones can be superimposed onto each other. Such superposition can create another sound known as a beat and/or portions of the one of the tones may server to attenuate or amplify portions of the other tone. Still alternatively, the tones can be synchronous or asynchronous.

In an alternate embodiment, the multi-tone frequency can include two or more frequencies either superimposed or emitted sequentially in an interlaced fashion and the two or more frequencies can be selected from any portion of the audible frequency range, approximately 0 Hz to approximately 20,000 Hz.

FIG. 5 shows the interior of the housing of the pacifier 100. In the embodiment shown in FIG. 5, the pacifier 100 shows that the light source 508 as an LED located inside the pacifier 100, behind the cover 104. However in alternate embodiments, the pacifier 100 can include multiple light sources 504 of any known type located at the perimeter of the housing 102 of the pacifier 100 and/or in any convenient location on the pacifier 100. Additionally, in alternate embodiments the light sources 504 can vary in number and can be located in any convenient location on the pacifier 100. Additionally, although described as an LED 504, any convenient and/or known light source can be used. Furthermore, any color of light source can be used. In still further alternate embodiments, fewer than described, more than described and/or no light source can be used.

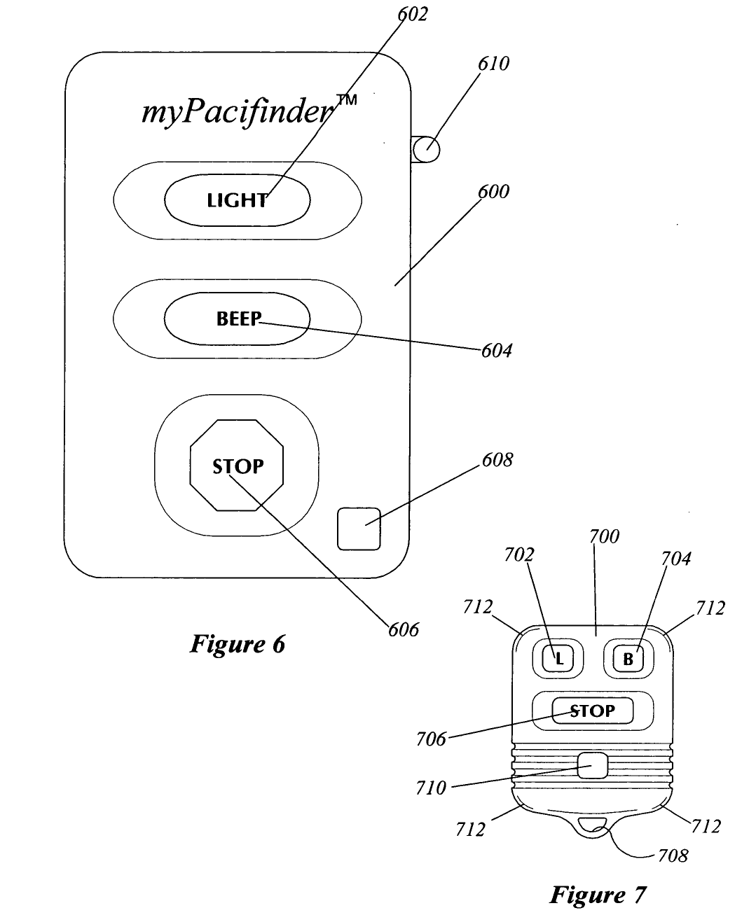

FIG. 6 shows the front side of a remote locator pager device 600. In the embodiment shown in FIG. 6, the pager device includes a casing and four buttons 602, 604, 606, 608 extending through the casing and an antenna 610. In the embodiment shown in FIG. 6, the antenna is depicted as an external omni-directional antenna. However, in alternate embodiments, the antenna can be any known and/or convenient type of antenna. In the embodiment shown in FIG. 6 the casing is made of an opaque plastic. However in alternate embodiments, the casing may be made of any convenient and/or known material. In the embodiment shown in FIG. 6, each of the four buttons 602, 604, 606, 608 is associated with a unique indicator marking. The indicator markings can be any convenient mechanism to differentiate the buttons by sight and/or touch. In alternate embodiments, the unique indicator markings may not be present. Additionally, in a further alternate embodiment, each of the buttons 602, 604, 606, 608 can have a unique color and/or a unique shape and/or number to facilitate identification.

In the embodiment shown in FIG. 6, button 602 can be labeled “light.” In some embodiments, when the button 602 is depressed, a signal can be sent to the pacifier 100 and the light source 508 on the pacifier can be triggered. The light source 508 can emit a solid continuous light or it can emit an intermittent light. In some embodiments, the light source 508 can emit various colored lights and/or can emit both light and an audible signal from the speaker 502. In some embodiments, the light source and/or audible signal can continue until terminated or can only be emitted for a predetermined period. In some embodiments, depression of the button 602 can result in the pacifier 100 emitting a light signal only.

In the embodiment shown in FIG. 6, button 604 can be labeled “Beep.” In some embodiments, when the button 604 is depressed, a signal can be sent to the pacifier 100 and the speaker 502 on the pacifier can be triggered. The speaker can emit any kind of audible signal as described above with reference to FIG. 5. In some embodiments, the light source 508 ca also emit a visual signal or the pacifier 100 can emit both a visible signal from the light source 508 and an audible signal from the speaker 502. In some embodiments, the light source and/or audible signal can continue until terminated or can only be emitted for a predetermined period. In some embodiments, depression of the button 604 can result in the pacifier 100 emitting an audible signal only.

In the embodiment shown in FIG. 6, button 606 can be labeled “Stop.” In some embodiments, when the button 606 is depressed, a signal can be sent to the pacifier 100 to halt audible, visual and/or both signals from being emitted by the pacifier 100. In alternate embodiments, when the button 606 is depressed, any single and/or multiple signals being transmitted by the remote locator pager device 600 can be terminated.

In the embodiment shown in FIG. 6, the button 608 can be labeled “Remote.” In some embodiments, when the button 608 is depressed, a signal can be sent to a remote device (700, FIG. 7) and a speaker on the remote device can be triggered. The speaker can emit any kind of audible signal as described above with reference to FIG. 5. In some embodiments, a light source can also emit a visual signal or the remote device 700 can emit both a visible signal from a light source and an audible signal from a speaker. In some embodiments, the light source and/or audible signal can continue until terminated or can only be emitted for a predetermined period. In some embodiments, depression of the button 608 can result in the remote device 700 emitting either an audible signal only or a visual signal only. Additionally, in alternate embodiments, pressing button 608 multiple times can result in the remote device emitting an audible signal, a visual signal, both an audible signal and a visual signal and/or stop the remote device from emitting any one or more audible or visual signals.

FIG. 7 depicts a remote device 700 with similar functionality to the remote locator pager device 600. In the embodiment shown in FIG. 7, the pager device includes a casing and three buttons 702, 704, 706 extending through the casing, and attachment mechanism 708, a speaker opening 710 and light sources 712. Internal to the casing are an antenna (not shown) a power source (not shown) and a speaker (not shown). In the embodiment shown in FIG. 7, the antenna can be a flat panel antenna and the power source can be a battery. However, in alternate embodiments the antenna can be any known and/or convenient type of antenna and the power source can be any know and or convenient power source. In the embodiment shown in FIG. 7 the casing is made of an opaque plastic. However in alternate embodiments, the casing may be made of any convenient and/or known material. In the embodiment shown in FIG. 7, each of the three buttons 702, 704, 706 is associated with a unique indicator marking. The indicator markings can be any convenient mechanism to differentiate the buttons by sight and/or touch. In alternate embodiments, the unique indicator markings may not be present. Additionally, in a further alternate embodiment, each of the buttons 702, 704, 706 can have a unique color and/or a unique shape and/or number to facilitate identification.

In the embodiment shown in FIG. 7, button 702 can be labeled “L.” In some embodiments, when the button 702 is depressed, a signal can be sent to the pacifier 100 and the light source 508 on the pacifier can be triggered. The light source 508 can emit a solid continuous light or it can emit an intermittent light. In some embodiments, the light source 508 can emit various colored lights and/or can emit both light and an audible signal from the speaker 502. In some embodiments, the light source and/or audible signal can continue until terminated or can only be emitted for a predetermined period. In some embodiments, depression of the button 702 can result in the pacifier 100 emitting a light signal only.

In the embodiment shown in FIG. 7, button 704 can be labeled “B.” In some embodiments, when the button 704 is depressed, a signal can be sent to the pacifier 100 and the speaker 502 on the pacifier can be triggered. The speaker can emit any kind of audible signal as described above with reference to FIG. 5. In some embodiments, the light source 508 ca also emit a visual signal or the pacifier 100 can emit both a visible signal from the light source 508 and an audible signal from the speaker 502. In some embodiments, the light source and/or audible signal can continue until terminated or can only be emitted for a predetermined period. In some embodiments, depression of the button 704 can result in the pacifier 100 emitting an audible signal only.

In the embodiment shown in FIG. 7, button 706 can be labeled “Stop.” In some embodiments, when the button 706 is depressed, a signal can be sent to the pacifier 100 to halt audible, visual and/or both signals from being emitted by the pacifier 100. In alternate embodiments, when the button 706 is depressed, any single and/or multiple signals being transmitted by the remote device 700 can be terminated.

In the embodiment shown in FIG. 7, the attachment mechanism 708 is an aperture in the casing which would allow attachment of the remote device 700 to any convenient item. In alternate embodiments, the attachment mechanism 708 can be any known and/or convenient mechanism.

The above-described system is a locating pager device for finding a misplaced and/or lost pacifier. In operation, the remote locator pager device 600 and/or the remote device 700 can send a signal to the pacifier 100 that can emit a multi-frequency audible tone and emit light upon activation by the appropriate signal. In the embodiments shown in FIGS. 1-7, the signals are radio frequency signals. However, in alternate embodiments, the signals can be any convenient type of signal.

While the system has been described with reference to specific embodiments, this description is not intended to be construed in a limiting sense. Various modifications of the disclosed embodiments, as well as other embodiments, will be apparent to persons skilled in the art upon reference to this description. It is therefore contemplated that the appended claims will cover any such modification or embodiments as fall within the true scope of the system described herein.

What is claimed is:

1. A pacifier locator system comprising:
a pacifier including a housing;
a speaker located within said housing;
a light source associated with said pacifier;
a transmitter capable of transmitting at least one signal; and
a receiver associated with said pacifier;
wherein said speaker emits an audible tone upon receiving said at least one signal; and
wherein said light source emits a visual signal upon receiving said at least one signal.

2. The pacifier locator system of claim 1 wherein the tone is comprised of at least two periodic interlaced tones.

3. The pacifier locator system of claim 2 wherein the periodic interlaced tones are asynchronous with one another.

4. The pacifier locator system of claim 2 wherein the periodic interlaced tones are selected from the frequency range from and including approximately 10,000 Hz to approximately 20,000 Hz.

5. The pacifier locator system of claim 2 wherein at least one of the asynchronous periodic interlaced tones is selected from the frequency range from and including approximately 0 Hz to approximately 10,000 Hz.

6. The pacifier locator system of claim 1 wherein the tone is comprised of at least two tones.

7. The pacifier locator system of claim 6 wherein the tones are synchronous with one another.

8. The pacifier locator system of claim 6 wherein the tones are periodic.

9. The pacifier locator system of claim 8 wherein the tones are continuous.

10. The pacifier locator system of claim 1 wherein the light source emits at least one of a continuous light and a periodic light upon receiving said at least one signal.

11. The object locator system of claim 1 wherein the transmitter comprises at least one speaker configured to emit an audible signal.

12. The object locator system of claim 11 wherein the transmitter emits said audible signal upon receipt of a search signal.

13. A method of locating a pacifier comprising:
coupling a receiver to a pacifier having a housing;
associating a speaker within said housing;
associating a speaker with said receiver;
associating a light source with said pacifier;
transmitting a signal from a transmitter configured to produce at least one signal;
emitting an audible tone from the speaker upon receipt of said at least one signal; and
emitting a visual signal from said light source upon receipt of said at least one signal.

14. The method of claim 13 wherein the audible tone comprises at least two periodic asynchronous interlaced tones.

15. The method of claim 13 wherein the audible tone comprises at least two synchronous tones.

16. The method of claim 13 wherein the audible tone comprises at least one of a continuous tone and a periodic tone.

17. The method of claim 13 wherein the audible tone signal comprises at least two continuous tones of different frequencies.

18. The method of claim 13 wherein the visual signal is continuously emitted.

19. The method of claim 13 wherein the visual signal is periodically emitted.
